(19) United States
(12) Patent Application Publication
(10) Pub. No.: US 2016/0370647 A1
(43) Pub. Date: Dec. 22, 2016

(54) COLOR FILTER SUBSTRATE, MANUFACTURING METHOD, AND LIQUID CRYSTAL PANEL

(71) Applicant: SHENZHEN CHINA STAR OPTOELECTRONICS TECHNOLOGY CO., LTD., Shenzhen, Guangdong (CN)

(72) Inventor: Jie CHEN, Shenzhen, Guangdong (CN)

(73) Assignee: Shenzhen China Star Optoelectronics Technology Co., Ltd., Shenzhen, Guangdong (CN)

(21) Appl. No.: 14/440,845

(22) PCT Filed: Apr. 9, 2015
(86) PCT No.: PCT/CN2015/076145

§ 371 Date: May 5, 2015

(30) Foreign Application Priority Data
Feb. 13, 2015 (CN) 201510080747.7

(51) Int. Cl. G02F 1/1335; G02F 1/1339

(52) U.S. Cl. CPC G02F 1/133514; G02F 1/133516; G02F 1/133512; G02F 1/13394; G02F 2201/121

(57) ABSTRACT

Provided is a color filter substrate, which includes a substrate body, a black matrix layer, a color resist unit layer, and a common electrode layer. The black matrix layer and the color resist unit layer are formed on the same surface of the substrate body. The common electrode layer is set on and covers the color resist unit layer. The color filter substrate includes a plastic frame formed on a circumference of the substrate body. The plastic frame includes bumps embedded therein. The bumps are formed of depositions of color resists during patternization of the color resist unit layer. Also provided are a method for manufacturing the color filter substrate and a liquid crystal panel.

### CROSS REFERENCE TO RELATED APPLICATIONS

This application claims the priority of Chinese Patent Application No. 201510080747.7, entitled “Color Filter Substrate, Manufacturing Method, and Liquid Crystal Panel”, filed on Feb. 13, 2015, the disclosure of which is incorporated herein by reference in its entirety.

### BACKGROUND OF THE INVENTION

1. Field of the Invention

The present invention relates to the field of manufacture of liquid crystal displays, and in particular to a color filter substrate, a manufacturing method, and a liquid crystal panel.

2. The Related Arts

Liquid crystal displays (LCDs), serving as a displaying component of electronic products, have now widely used as liquid crystal display devices in various electronic products. A liquid crystal panel comprises an array substrate, a color filter substrate, and liquid crystal interposed between the array substrate and the color filter substrate. A plastic frame is formed between the color filter substrate and the array substrate to enclose and seal the liquid crystal. Spacers are arranged between the color filter substrate and the array substrate. During a manufacturing process, to ensure sufficient support strength of the plastic frame, fibers may be added in the formation of the plastic frame. However, a large amount of fibrous material, as well as associated facility, may be needed. This increases the manufacturing cost.

### SUMMARY OF THE INVENTION

The present invention provides a color filter substrate and a manufacturing method thereof, which ensure sufficient support strength of a plastic frame and save cost.

The present invention also relates to a liquid crystal panel.

The present invention provides a color filter substrate, which comprises a substrate body, a black matrix layer, a color resist unit layer, and a common electrode layer. The black matrix layer and the color resist unit layer are formed on the same surface of the substrate body. The common electrode layer is set on and covers the color resist unit layer. The color filter substrate comprises a plastic frame formed on a circumference of the substrate body and the plastic frame comprises bumps embedded therein. The bumps are formed of depositions of color resists during the formations of the color resist unit layer.

In the above color filter substrate, the color resist unit layer comprises a plurality of RGB color resist units.

In the above color filter substrate, the bumps are formed of deposition of color resist of one color or multiple colors.

In the above color filter substrate, the RGB color resist units comprise a first color resist, a second color resist, and a third color resist.

In the above color filter substrate, the color resist unit layer are subjected to patternization that comprises three processes of exposure and development and the bumps are formed in at least one of the three processes of exposure and development.

The present invention also provides a method for manufacturing a color filter substrate, which comprises the following steps:

providing a substrate body;

forming a black matrix on the substrate body, wherein a surface of the substrate body on which the black matrix is formed has a circumference on which a plastic frame area is defined;

coating a RGB color resist layer on the substrate body, resist of at least one color of the RGB being deposited in the plastic frame area;

subjecting the RGB color resist layer to patternization to form a color resist unit layer, bumps being simultaneously formed of depositions of the RGB color resists in the plastic frame area;

subjecting the substrate body to patternization to form a common electrode layer, the common electrode layer covering the color resist unit layer; and

filling a plastic material into the plastic frame area to form a plastic frame, wherein the bumps are embedded in the plastic frame.

In the above method, the step of “subjecting the RGB color resist layer to patternization to form a color resist unit layer, bumps being simultaneously formed of depositions of the RGB color resists in the plastic frame area” comprises a step in which a first color resist layer, a second color resist layer, and a third color resist layer are sequentially coated on the substrate body and are individually subjected to a process of exposure and development to form the color resist unit layer and a step in which the bumps are formed in at least one process of exposure and development of the first color resist layer, the second color resist layer, and the third color resist layer.

In the above method, the step in which the bumps are formed in at least one process of exposure and development of the first color resist layer, the second color resist layer, and the third color resist layer comprises subjecting the first color resist to the process of exposure and development to form the bumps, or subjecting the first color resist layer and the second color resist layer to the processes of exposure and development and then stacking to form the bumps, or subjecting the three color resists of the first color resist layer, the second color resist layer, and the third color resist layer the processes of exposure and development and then stacking to form the bumps.

The above method for manufacturing the color filter substrate further comprises a step of forming a plurality of spacers on the color resist unit layer of the substrate body.

The present invention also provides a liquid crystal panel, which comprises an array substrate and a color filter substrate opposite to the array substrate. The color filter substrate comprises a substrate body, a black matrix layer, a color resist unit layer, and a common electrode layer. The black matrix layer and the color resist unit layer are formed on the same surface of the substrate body. The common electrode layer is set on and covers the color resist unit layer. The color filter substrate comprises a plastic frame formed on a circumference of the substrate body and the plastic frame comprises bumps embedded therein. The bumps re formed during patternization of the color resist unit layer. The array substrate and the color filter substrate hold and interpose the plastic frame therebetween to form a hollow cavity in which liquid crystal is received.

The color filter substrate according to the present invention is structured in such a way that at the same of forming a color resist unit layer, color resists are deposited in a plastic frame area to form bumps, which are then embedded in a plastic frame during the formation of the plastic frame. This enhances the support strength of the plastic frame and forming the bumps during the formation of the color resist unit layer can save operation steps and costs.

### BRIEF DESCRIPTION OF THE DRAWINGS

To more clearly explain the technical solutions proposed in embodiments of the present invention or those of the prior art, a brief description of the drawings that are necessary for describing the embodiments of the present invention or those of the prior art is given as follows. It is obvious that the drawings that will be described below show only some embodiments of the present invention. For those having ordinary skills of the art, other drawings may also be readily available from these attached drawings without the expense of creative effort and endeavor.

FIG. 1 is a cross-sectional view showing a color filter substrate according to the present invention;

FIG. 2 is a flow chart illustrating a method for manufacturing the color filter substrate of FIG. 1; and

FIG. 3 is a cross-sectional view showing a liquid crystal panel according to the present invention.

### DETAILED DESCRIPTION OF THE PREFERRED EMBODIMENTS

A clear and complete description will be given to technical solutions of the embodiments of the present invention with reference to the attached drawings of the embodiments of the present invention. However, the embodiments so described are only some, but not all, of the embodiments of the present invention. Other embodiments that are available to those having ordinary skills of the art without the expense of creative effort and endeavor are considered belonging to the scope of protection of the present invention.

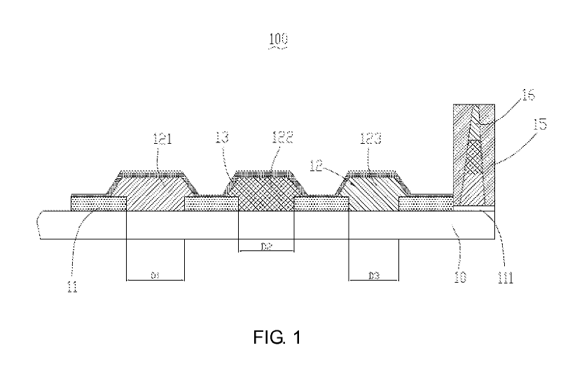

Referring to FIG. 1, the present invention protects a color filter substrate 100, which comprises a substrate body 10, a black matrix layer 11, a color resist unit layer 12, and a common electrode layer 13. The black matrix layer 11 and the color resist unit layer 12 are formed on the same surface of the substrate body 10. The common electrode layer 13 is set on and covers the color resist unit layer 12. The color filter substrate comprises a plastic frame 15 formed thereon along a circumference of the substrate body 10. The plastic frame 15 comprises bumps 16 embedded therein. The bumps 16 are formed of depositions of color resists during the formation of the color resist unit layer 12. Specifically, during patternization of the color resist unit layer 12, color resists are deposited in the area of the plastic frame 15 form bumps that are separate from the color resist unit layer 12. The number of the bumps 16 used is determined according to the needs of the color filter substrate. The black matrix layer 11 comprises a grating structure formed of an arrangement of longitudinal and lateral lines intersecting each other.

Further, the color resist unit layer 12 comprises a plurality of RGB color resist units. The RGB color resist units comprise a first color resist 121, a second color resist 122, and a third color resist 123. The first color resist 121, the second color resist 122, and the third resist 123 are respectively red, green, and the yellow color resists. The first color resist 121, the second color resist 122, and the third color resist 123 of the plurality of RGB color resist units are arranged to space from each other to form a grating form. The black matrix layer 11 is arranged to alternate with the first color resist 121, the second color resist 122, and the third color resist 123 to show a grating like interposition arrangement.

Further, the bumps 16 can be formed of deposition of resist of a single color or resist of multiple colors. Specifically, the bumps 16 are formed of the first color resist 121 or are alternatively formed of deposition of the first color resist 121 and the second color resist 122 or further alternatively formed of simultaneous deposition of two or three of the first color resist 121, the second color resist 122, and the third color resist 123, and are preferably, in the instant embodiment, formed of stacked depositions of the first color resist 121, the second color resist 122, and the third color resist 123.

Further, the patternization of the color resist unit layer 12 comprises three processes of exposure and development. The bumps 16 are formed in at least one of the three processes of exposure and development. In the instant embodiment, the bumps 16 are formed through deposition of three color resists performed in three processes of exposure and development.

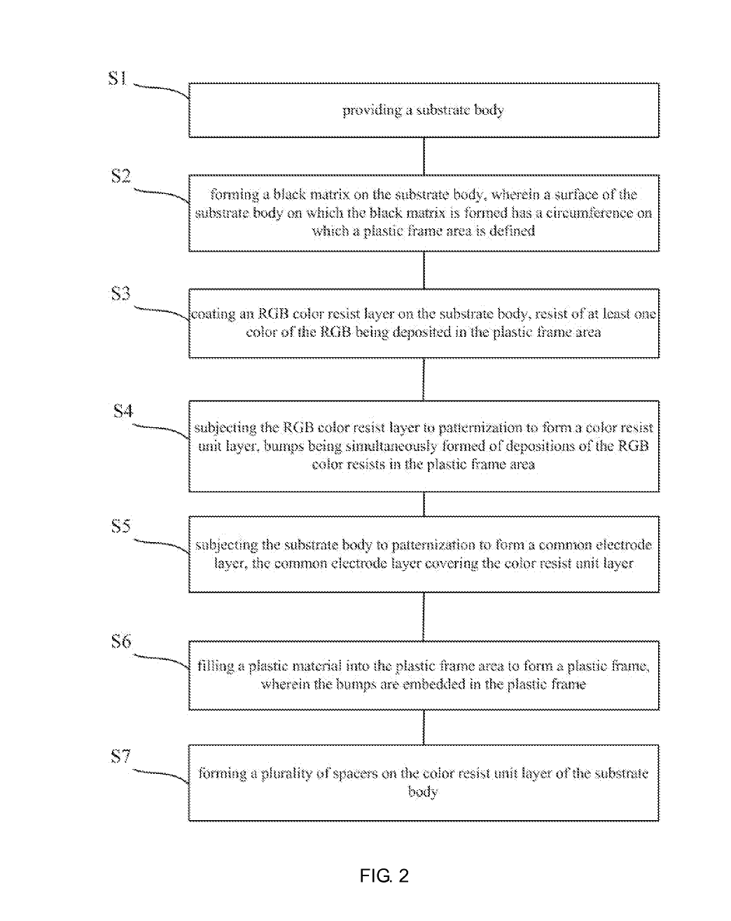

Referring to FIG. 2, the present invention also provides a method for manufacturing a color filter substrate. The method comprises the following steps:

Step S1: providing a substrate body.

Step S2: forming a black matrix on the substrate body, wherein a surface of the substrate body on which the black matrix is formed has a circumference on which a plastic frame area is defined.

Step S3: coating a RGB color resist layer on the substrate body, resist of at least one color of the RGB being deposited in the plastic frame area.

Step S4: subjecting the RGB color resist layer to patternization to form a color resist unit layer, bumps being simultaneously formed of depositions of the RGB color resists in the plastic frame area.

Step S5: subjecting the substrate body to patternization to form a common electrode layer, the common electrode layer covering the color resist unit layer.

Step S6: filling a plastic material into the plastic frame area to form a plastic frame, wherein the bumps are embedded in the plastic frame.

Step S7: forming a plurality of spacers on the color resist unit layer of the substrate body.

Further, Step S4 further comprises Step S41, which is a step in which a first color resist layer, a second color resist layer, and a third color resist layer are sequentially coated on the substrate body and are individually subjected to a process of exposure and development to form the color resist unit layer; and Step S42, in which bumps are formed in at least one of the processes of exposure and development of the first color resist layer, the second color resist layer, and the third color resist layer.

Further, Step S42 further comprises subjecting the first color resist layer to the exposure and development to form the bumps, or alternatively subjecting the first color resist layer and the second color resist layer to the exposures and developments and then stacking to form the bumps, or further alternatively, subjecting the three color resists of the first color resist layer, the second color resist layer, and the third color resist layer to exposures and developments and then stacking to form the bumps.

In the instant embodiment, the color filter substrate 100 shown in FIG. 1 will be taken as an example for illustrating, in detail, the above manufacturing method of the color filter substrate.

The substrate body 10 of the instant embodiment is a glass panel, which has a surface (not labeled).

A black matrix layer 11 is formed on the surface of the substrate body 10. The surface of the substrate body 10 on which the black matrix layer 11 is formed has a circumference on which a plastic frame area 111 is defined. Specifically, the black matrix layer 11 is formed by subjecting photo resists coated on the surface to patternization operations, including exposure and development and spacing zones D1, D2, and D3 are formed to alternate with the black matrix layer 11.

Then, an RGB color resist layer is coated on the substrate body 10 that comprises the black matrix layer 11 formed thereon. The RGB color resist layer covers the plastic frame area 111. The RGB color resist layer comprises three types of resists, including first color resist 121, second color resist 122, and third color resist 123. The first color resist 121, the second color resist 122, and the third color resist 12 are respectively red color resist, green color resist, and yellow color resist. Specifically, a first color resist layer, a second color resist layer, and a third color resist layer are sequentially coated on the substrate body 10 and a process of exposure and development is conducted after each of the coating operations so as to form the red color resist in the spacing zone D1, the green color resist in D2, and the yellow color resist in the spacing zone D3, whereby each group consisting of the spacing zones D1, D2, and D3 constitutes a color resist unit. A number of the color resist units collectively form the color resist unit layer 12. At the same time when the processes of exposure and development are conducted for the first color resist layer, the second color resist layer, and the third color resist layer, through development and exposure, the color resists located in the plastic frame area 111 are separated from the color resist units and thus form pillar like bumps 16 in the plastic frame area 111. The bumps 16 are formed by stacked depositions of the first color resist, the second color resist, and the third color resist.

A common electrode layer 13 is formed on substrate body 10 that comprises the color resist unit layer 12 formed thereon. This is generally achieved through patternization operations, including exposure and development. Then, a plastic material is filled into the plastic frame area 11 to form a plastic frame 15. The bumps 16 are embedded in the plastic frame 17. Finally, a plurality of spacers (not shown) is formed on the color resist unit layer 12 of the substrate body 11.

The color filter substrate 100 according to the present invention is structured in such a way that at the same of forming a color resist unit layer 12, color resists are deposited in a plastic frame area to form bumps, which are then embedded in a plastic frame during the formation of the plastic frame. This enhances the support strength of the plastic frame and forming the bumps during the formation of the color resist unit layer can save operation steps and costs.

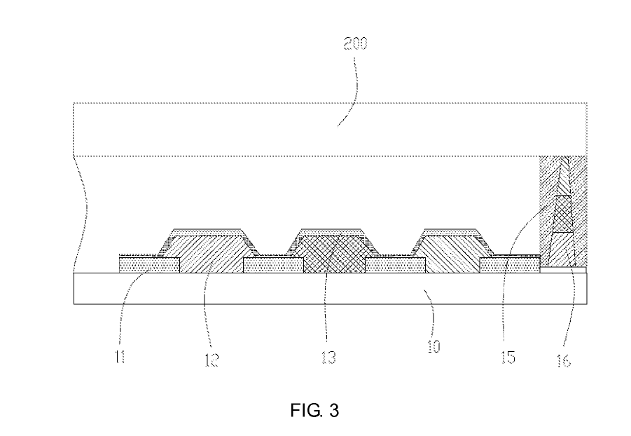

Referring to FIG. 3, the present invention also provides a liquid crystal panel, which comprises an array substrate 200 and the color filter substrate 100 that has been described above and is opposite to the array substrate 200. The array substrate 200 and the color filter substrate 100 hold and interpose the plastic frame 15 therebetween to form a hollow cavity in which liquid crystal is received.

The manufacturing process of patternization mentioned above can be achieved through the known photolithographic art and etching and known art for patternization including patternization operations, photo resist, and exposure machines. Repeated description will be not necessary here.

The above illustrates only a preferred embodiment according to the present invention and is not intended to limit the scope of right of the present invention. Those having ordinary skills of the art would appreciate that various equivalent modifications that achieve all or some of the operations of the above-described embodiment and fall within scope of the attached claims are considered within the scope covered by the present invention.

What is claimed is:

1. A color filter substrate, comprising a substrate body, a black matrix layer, a color resist unit layer, and a common electrode layer, the black matrix layer and the color resist unit layer being formed on the same surface of the substrate body, the common electrode layer being set on and covering the color resist unit layer, wherein the color filter substrate comprises a plastic frame formed on a circumference of the substrate body and the plastic frame comprises bumps embedded therein, the bumps being formed of depositions of color resists during the formations of the color resist unit layer.

2. The color filter substrate as claimed in claim 1, wherein the color resist unit layer comprises a plurality of RGB color resist units.

3. The color filter substrate as claimed in claim 1, wherein the bumps are formed of deposition of color resist of one color or multiple colors.

4. The color filter substrate as claimed in claim 2, wherein the RGB color resist units comprise a first color resist, a second color resist, and a third color resist.

5. The color filter substrate as claimed in claim 1, wherein the color resist unit layer are subjected to patternization that comprises three processes of exposure and development, the bumps being formed in at least one of the three processes of exposure and development.

6. A method for manufacturing a color filter substrate, comprising the following steps:
providing a substrate body;
forming a black matrix on the substrate body, wherein a surface of the substrate body on which the black matrix is formed has a circumference on which a plastic frame area is defined;
coating an RGB color resist layer on the substrate body, resist of at least one color of the RGB being deposited in the plastic frame area;
subjecting the RGB color resist layer to patternization to form a color resist unit layer, bumps being simultaneously formed of depositions of the RGB color resists in the plastic frame area;
subjecting the substrate body to patternization to form a common electrode layer, the common electrode layer covering the color resist unit layer; and
filling a plastic material into the plastic frame area to form a plastic frame, wherein the bumps are embedded in the plastic frame.

7. The method for manufacturing the color filter substrate as claimed in claim 6, wherein the step of “subjecting the RGB color resist layer to patternization to form a color resist unit layer, bumps being simultaneously formed of depositions of the RGB color resists in the plastic frame area” comprises a step in which a first color resist layer, a second color resist layer, and a third color resist layer are sequentially coated on the substrate body and are individually subjected to a process of exposure and development to form the color resist unit layer and a step in which the bumps are formed in at least one process of exposure and development of the first color resist layer, the second color resist layer, and the third color resist layer.

8. The method for manufacturing the color filter substrate as claimed in claim 7, wherein the step in which the bumps are formed in at least one process of exposure and development of the first color resist layer, the second color resist layer, and the third color resist layer comprises subjecting the first color resist to the process of exposure and development to form the bumps, or subjecting the first color resist layer and the second color resist layer to the processes of exposure and development and then stacking to form the bumps, or subjecting the three color resists of the first color resist layer, the second color resist layer, and the third color resist layer the processes of exposure and development and then stacking to form the bumps.

9. The method for manufacturing the color filter substrate as claimed in claim 7, wherein the method for manufacturing the color filter substrate further comprises a step of forming a plurality of spacers on the color resist unit layer of the substrate body.

10. A liquid crystal panel, comprising an array substrate and a color filter substrate opposite to the array substrate, the color filter substrate comprising a substrate body, a black matrix layer, a color resist unit layer, and a common electrode layer, the black matrix layer and the color resist unit layer being formed on the same surface of the substrate body, the common electrode layer being set on and covering the color resist unit layer, wherein the color filter substrate comprises a plastic frame formed on a circumference of the substrate body and the plastic frame comprises bumps embedded therein, the bumps being formed during patternization of the color resist unit layer, the array substrate and the color filter substrate holding and interposing the plastic frame therebetween to form a hollow cavity in which liquid crystal is received.
